(19) United States
(12) Patent Application Publication
(10) Pub. No.: US 2022/0230124 A1
(43) Pub. Date: Jul. 21, 2022

(54) INFORMATION PROCESSING APPARATUS, METHOD, AND NON-TRANSITORY COMPUTER READABLE MEDIUM

(71) Applicant: Toyota Jidosha Kabushiki Kaisha, Toyota-shi (JP)

(72) Inventors: Masatoshi HAYASHI, Nisshin-shi (JP); Tadahiro KASHIWAI, Nagoya-shi (JP); Shintaro MATSUTANI, Kariya-shi (JP)

(73) Assignee: Toyota Jidosha Kabushiki Kaisha, Toyota-shi (JP)

(21) Appl. No.: 17/573,199

(22) Filed: Jan. 11, 2022

(30) Foreign Application Priority Data
Jan. 15, 2021 (JP) 2021-005296

(51) Int. Cl. G06Q 10/06; G06Q 50/26; G06Q 10/10

(52) U.S. Cl. CPC G06Q 10/063112; G06Q 10/063116; G06Q 10/1093; G06Q 50/265

(57) ABSTRACT

An information processing apparatus includes a memory and a controller. The memory stores primary information regarding a plurality of relief vehicles that can be dispatched to a facility located in a disaster area in case of a disaster and secondary information regarding a plurality of drivers who can drive relief vehicles in case of a disaster. The controller is configured to acquire tertiary information regarding a facility located in a disaster area in need of relief and perform processing for determining a combination of a relief vehicle included in the plurality of relief vehicles and a driver included in the plurality of drivers that is to be dispatched to the facility located in the disaster area, based on the primary information, the secondary information, and the tertiary information.

### CROSS-REFERENCE TO RELATED APPLICATION

This application claims priority to Japanese Patent Application No. 2021-05296, filed on Jan. 15, 2021, the entire contents of which are incorporated herein by reference.

### TECHNICAL FIELD

The present disclosure relates to an information processing apparatus, a method, and a non-transitory computer readable medium that determine a combination of a driver and a relief vehicle to be dispatched to a facility located in a disaster area in case of a disaster.

### BACKGROUND

Systems have been proposed to dispatch power supply vehicles, such as hybrid vehicles or electric vehicles, capable of supplying electric power to the outside of the vehicles, so as to perform power supply to multiple facilities used as evacuation shelters in a disaster area, during a power shortage caused by the disaster (for example, Patent Literature 1).

### CITATION LIST

### Patent Literature

PTL 1: JP 2017-112806 A

### SUMMARY

According to known technology, a server determines to which facilities power supply is to be performed from power supply vehicles, based on information on facilities used as evacuation shelters and information on the power supply vehicles, and makes a notification to the owners of the power supply vehicles. To dispatch relief vehicles, such as power supply vehicles, for providing relief to a disaster area, however, drivers are needed to drive the vehicles to facilities located in the disaster area. The owners or managers of the relief vehicles are sometimes not able to drive the vehicles to the disaster area, even though they may be able to provide the vehicles.

It would be helpful to provide an information processing apparatus, a method, and a program that are capable of determining a combination of a relief vehicle and a driver for efficiently providing relief to a facility located in a disaster area.

An information processing apparatus according to an embodiment of the present disclosure includes a memory and a controller. The memory stores primary information regarding a plurality of relief vehicles that can be dispatched to a facility located in a disaster area in case of a disaster and secondary information regarding a plurality of drivers who can drive relief vehicles in case of a disaster. The controller is configured to acquire tertiary information regarding a facility located in a disaster area in need of relief and perform processing for determining a combination of a relief vehicle included in the plurality of relief vehicles and a driver included in the plurality of drivers that is to be dispatched to the facility located in the disaster area, based on the primary information, the secondary information, and the tertiary information.

A method according to an embodiment of the present disclosure is a method, executed by a controller of an information processing apparatus, for determining a combination of a relief vehicle and a driver. The method includes acquiring primary information regarding a plurality of relief vehicles that can be dispatched to a facility located in a disaster area in case of a disaster, and acquiring secondary information regarding a plurality of drivers who can drive relief vehicles in case of a disaster. The method includes acquiring tertiary information regarding a facility located in a disaster area in need of relief, and determining a combination of a relief vehicle included in the plurality of relief vehicles and a driver included in the plurality of drivers that is to be dispatched to the facility located in the disaster area, based on the primary information, the secondary information, and the tertiary information.

A non-transitory computer readable medium according to an embodiment of the present disclosure stores a program. The program is configured to cause a computer to execute operations including acquiring primary information regarding a plurality of relief vehicles that can be dispatched to a facility located in a disaster area in case of a disaster, and acquiring secondary information regarding a plurality of drivers who can drive relief vehicles in case of a disaster. The program is further configured to cause the computer to execute operations including acquiring tertiary information regarding a facility located in a disaster area in need of relief, and determining a combination of a relief vehicle included in the plurality of relief vehicles and a driver included in the plurality of drivers that is to be dispatched to the facility located in the disaster area, based on the primary information, the secondary information, and the tertiary information.

According to the present disclosure, the information processing apparatus, the method, and the non-transitory computer readable medium that are capable of determining a combination of a relief vehicle and a driver for efficiently providing relief to a facility located in a disaster area can be provided.

### BRIEF DESCRIPTION OF THE DRAWINGS

In the accompanying drawings:

FIG. 1 is a schematic diagram illustrating a disaster area relief system that provides relief to a facility located in a disaster area using an information processing apparatus according to an embodiment of the present disclosure;

FIG. 2 is a block diagram illustrating an information system used in the disaster area relief system in FIG. 1;

FIG. 3 is a block diagram illustrating a schematic configuration of the information processing apparatus;

FIG. 4 is a flowchart illustrating operations of the information processing apparatus; and

FIG. 5 is a flowchart for determining a combination of a relief vehicle and a driver.

### DETAILED DESCRIPTION

An embodiment of the present disclosure will be described below, with reference to the drawings.

(Overall Configuration of Disaster Area Relief System)

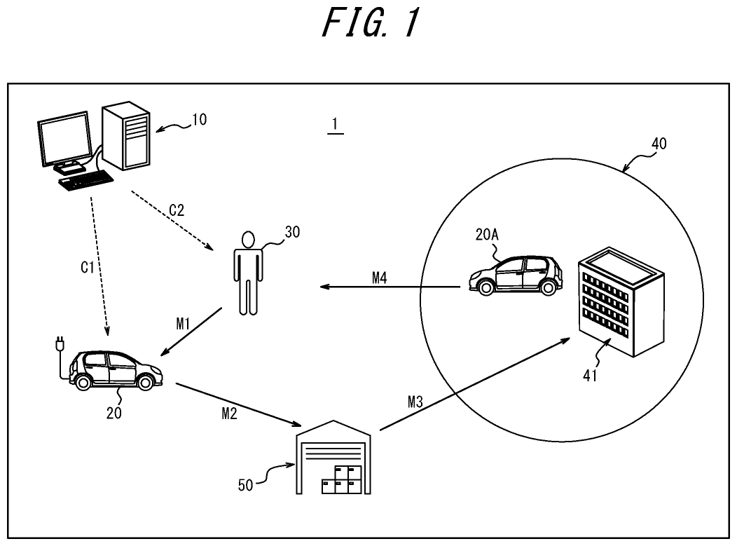

With reference to FIG. 1, an overview of a disaster area relief system 1 that provides relief to a facility 41 located in a disaster area 40 in need of relief using an information processing apparatus 10 according to the embodiment of the present disclosure will be described. The disaster area relief system 1 is a system in which information on a plurality of relief vehicles 20 and a plurality of drivers 30 is accumulated in advance in the information processing apparatus 10 and a combination of a relief vehicle 20 and a driver 30 is dispatched to at least one facility 41 located in the disaster area 40 in case of a disaster. The facility 41 is, for example, an evacuation shelter for disaster victims to evacuate to. At least one relief vehicle 20 and at least one driver 30 may be dispatched to a single facility 41.

The relief vehicle 20 is a vehicle that can provide an appropriate relief to the facility 41 located in the disaster area 40. The relief vehicle 20 includes a power supply vehicle, such as a hybrid vehicle or an electric vehicle, that is capable of supplying electric power. The relief vehicle 20 includes a vehicle capable of transporting relief supplies for disaster victims or transporting persons, such as volunteers, or includes a vehicle in which disaster victims can sleep overnight. The relief vehicle 20 may be a vehicle owned by a public sector entity, such as a municipality, or a vehicle owned by an individual or a company. The relief vehicle 20 may be a vehicle located within the disaster area 40, or a vehicle located outside the disaster area. In the present embodiment, the relief vehicle 20 is described as being located outside the disaster area 40. The relief vehicle 20 may be used for normal purposes, such as commuting and leisure, in normal times when no disaster has occurred. The relief vehicle 20 may be capable of automated driving such as any one of Level 1 to Level 5 as defined by the Society of Automotive Engineers (SAE), for example.

The driver 30 is an individual who can drive the relief vehicle 20 in case of a disaster. Typically, the driver 30 is a volunteer who provides relief to the disaster area.

In normal times, information on the relief vehicle 20 can be registered in advance on the information processing apparatus 10 by a manager of the relief vehicle 20. In the present disclosure, the manager of the relief vehicle 20 includes an owner of the relief vehicle 20, in a case in which the relief vehicle 20 is owned by an individual. In the present disclosure, information on the plurality of dispatchable relief vehicles 20 is referred to as relief vehicle information. The relief vehicle information is primary information.

In normal times, information on the driver 30 can be registered in advance on the information processing apparatus 10 by an individual who can be the driver 30 in case of a disaster. Information on the plurality of drivers 30 is referred to as driver information. The driver information is secondary information.

In case of a disaster, the information processing apparatus 10 acquires information on the needs of the facility 41 located in the disaster area 40 in need of relief. The information on the needs is tertiary information. Based on the relief vehicle information, the driver information, and the information on the needs, the information processing apparatus 10 can perform processing for determining at least one combination of a relief vehicle 20 included in the plurality of relief vehicles 20 and a driver 30 included in the plurality of drivers 30.

In FIG. 1, communications C1 and C2, including transmission of information, are indicated by dashed arrows, and movements M1 to M4 of a person or a vehicle is indicated by solid arrows.

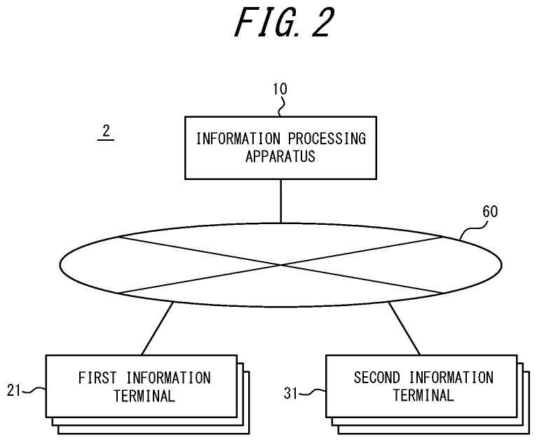

The information processing apparatus 10 transmits, to the manager of the relief vehicle 20, which is to be dispatched to the facility 41, and to the driver 30, a schedule according to which the relief vehicle 20 and the driver 30 are to be dispatched to the facility 41 (communications C1 and C2). The driver 30 travels to the position of the relief vehicle 20 according to the received schedule (movement M1) and boards the relief vehicle 20. The driver 30 may receive a key for the relief vehicle 20 from the manager of the relief vehicle 20 and board the relief vehicle 20. Alternatively, the driver 30 may receive an electronic key for the relief vehicle 20 that can be temporarily used from the information processing apparatus 10 on a later-described second information terminal 31 (refer to FIG. 2), and use this electronic key to board the relief vehicle 20.

The driver 30 boards the relief vehicle 20 and travels according to the received schedule. For example, the driver 30 may board the relief vehicle 20 and travel to a base 50 (movement M2). At the base 50, the driver 30 loads the relief vehicle 20 with relief supplies that are to be transported to the facility 41. In this case, the base 50 can be a warehouse for storing the relief supplies. After loading the relief supplies, the driver 30 travels to the facility 41 (movement M3). The relief vehicle 20 may allow volunteers, not supplies, to board at the base 50. In a case in which the relief vehicle 20 is a power supply vehicle or a vehicle provided with equipment to be used in the facility 41, the relief vehicle 20 may travel directly to the facility 41 without going through the base 50. As described above, the relief vehicle 20 can deliver, to the facility 41 located in the disaster area 40, needed electric power, supplies, volunteers, and/or equipment accompanying the vehicle, for example.

After arriving at the facility 41 and handing over the relief vehicle 20 to the facility 41, the driver 30 may board another relief vehicle 20A and return toward their original position, according to the schedule that has been generated by the information processing apparatus 10 (movement M4). For example, in a case in which the relief vehicle 20 is a power supply vehicle, the driver 30 may return toward a position at which the driver 30 is normally located, by boarding another relief vehicle 20A, which is another power supply vehicle that has performed power supply. The information processing apparatus 10 may coordinate schedules for a plurality of relief vehicles 20 to perform power supply with schedules for a plurality of drivers 30, so that the drivers 30 can return toward their normally located positions in an efficient manner.

(Configuration of Information Processing System Used in Disaster Area Relief System)

As illustrated in FIG. 2, the information processing system 2 of the disaster area relief system 1 includes the information processing apparatus 10, a plurality of first information terminals 21 in the possession of the respective managers of the relief vehicles 20, and a plurality of second information terminals 31 in the possession of the respective drivers 30. Each first information terminal 21 can be a personal computer, a smartphone, or a portable information terminal that is in the possession of the manager of a relief vehicle 20, or an in-vehicle information terminal installed in the relief vehicle 20. The manager of the relief vehicle 20 transmits and receives information to and from the information processing apparatus 10 using the first information terminal 21. Each second information terminal 31 can be a personal computer, a smartphone, or a portable information terminal in the possession of a driver 30. The driver 30 transmits and receives information to and from the information processing apparatus 10 using the second information terminal 31. As the first information terminal 21 and the second information terminal 31, any general purpose terminal may be used as appropriate.

The information processing apparatus 10, the first information terminals 21, and the second information terminals 31 each have a communication function and are capable of communicating with each other via a network 60. The network 60 includes a public network such as the Internet, and a mobile phone network. For transmission and receipt of information between the information processing apparatus 10, the first information terminals 21, and the second information terminals 31, known communication means, such as by e-mail or through a web browser, or dedicated communication means may be used.

(Configuration of Information Processing Apparatus)

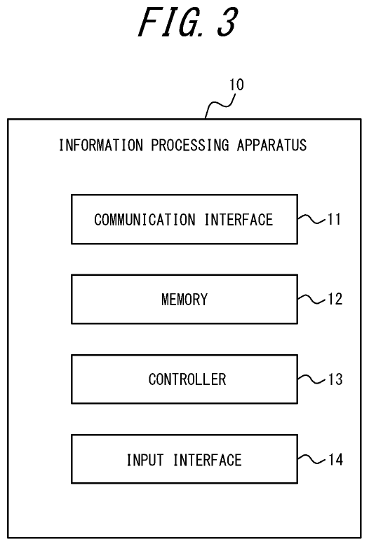

As illustrated in FIG. 3, the information processing apparatus 10 includes a communication interface 11, a memory 12, and a controller 13. The information processing apparatus 10 may further include an input interface 14.

The communication interface 11 is configured to transmit and receive information to and from the outside of the information processing apparatus 10. The communication interface 11 includes at least one communication interface for connection to the network 60. The communication interface is compliant with mobile communication standards, wired Local Area Network (LAN) standards, or wireless LAN standards, for example, but is not limited to these, and may be compliant with any communication standards. In the present embodiment, the information processing apparatus 10 can communicate with the first information terminals 21 in the possession of the managers of the relief vehicles 20 and the second information terminals 31 in the possession of the drivers 30, via the communication interface 11 and the network 60.

The memory 12 includes one or more memories. The memories included in the memory 12 may each function as, for example, a main memory, an auxiliary memory, or a cache memory. The memory 12 stores any information used for operations of the information processing apparatus 10. For example, the memory 12 stores relief vehicle information and driver information. For example, the memory 12 may store a system program, an application program, map information, or the like. The memory 12 may include a database managed by a database management system. The information stored in the memory 12 may be updated with, for example, information acquired from the network 60 via the communication interface 11.

The controller 13 includes at least one processor, at least one programmable circuit, at least one dedicated circuit, or a combination of these. The controller 13 controls the operations of the entire information processing apparatus 10.

The input interface 14 includes an input device for inputting various types of information to the information processing apparatus 10. The input interface 14 may include, for example, a keyboard, a mouse, a touch panel, a microphone for voice recognition, or the like.

(Processing Flow in Information Processing Apparatus)

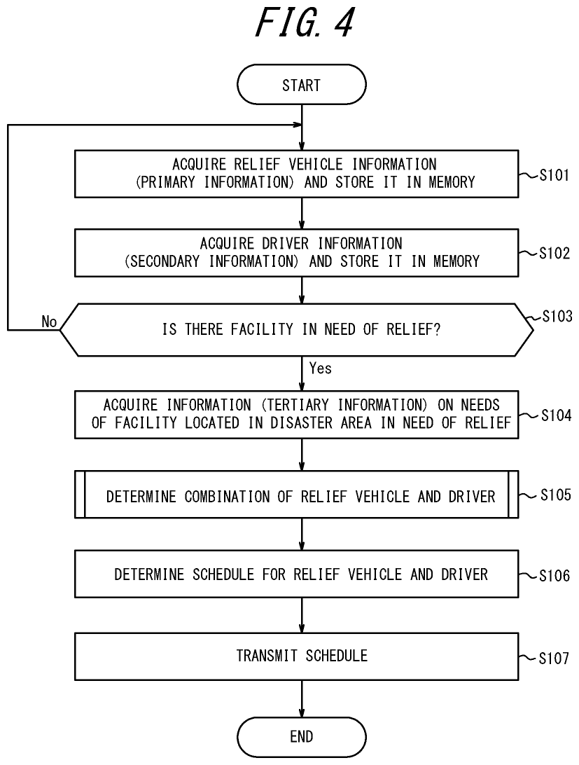

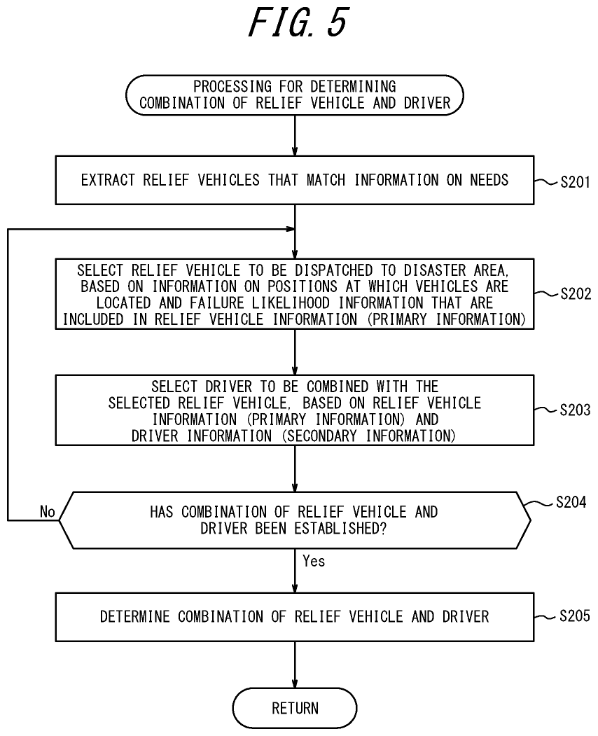

With reference to FIG. 4 and FIG. 5, processing executed by the controller 13 of the information processing apparatus 10 will be described.

First, in normal times when no disaster has occurred, the controller 13 can accept registration of relief vehicle information from the managers of the relief vehicles 20. The managers of the relief vehicles 20 register various types of information regarding the relief vehicles 20 on the information processing apparatus 10, by operating the first information terminals 21. The controller 13 acquires the relief vehicle information via the communication interface 11 and stores it in the memory 12 (Step S101). The relief vehicle information can also be inputted by an operator of the information processing apparatus 10 through the input interface 14, based on information that has been received from the managers of the relief vehicles 20.

The relief vehicle information includes information on the owners of the relief vehicles 20 and positions at which the relief vehicles 20 are normally located. The information on the positions at which the relief vehicles 20 are normally located is primary positional information. The information on the owners may include information identifying the owners (e.g., their names), and information on how to contact the owners (e.g., their email addresses). The information on the normally located positions may be, for example, information indicating the positions of garages for the relief vehicles 20. The positions at which the relief vehicles 20 are normally located may be specified, for example, by latitudes and longitudes.

The relief vehicle information includes information on the functions and equipment that can be provided by the relief vehicles 20. For example, the relief vehicle information may include information that the relief vehicles 20 are power supply vehicles capable of supplying electric power to the outside of the relief vehicles 20, and information on the capacity of electric power that can be supplied. The relief vehicle information may include information on the volume loadable into each relief vehicle 20. The relief vehicle information may include information on the count of persons who can board each relief vehicle 20. Further, in a case in which the relief vehicles 20 are provided with equipment that allows one to sleep overnight in there, the relief vehicle information may include this information. In case of a disaster, the information on the functions and equipment that can be provided by the relief vehicles 20 is collated with information on the relief that is needed by a facility 41 included in information on needs.

The relief vehicle information stored in the memory 12 may include primary vehicle attribute information indicating the attributes of the relief vehicles 20. The primary vehicle attribute information may include information on the type, size, and maneuverability of each relief vehicle 20. The type of relief vehicle 20 includes compact car, sedan, minivan, Sport Utility Vehicle (SUV), and other vehicle types. The information on size may include information on the overall length, overall width, and overall height of each relief vehicle 20. The information on the maneuverability of each relief vehicle 20 includes, for example, information on the transmission system (whether it is a manual transmission or an automatic transmission), the position of the shift lever (whether it is a floor shift lever, an instrument panel shift lever, or a column shift lever), or the like. Further, the information on the maneuverability of each relief vehicle 20 includes information on the type of parking brake (whether it is a handbrake, a foot brake, or an electric parking brake), how to operate the turn signals (whether one-touch turn signals are adopted), or the like.

The relief vehicle information stored in the memory 12 may include failure probability information indicating probabilities of occurrence of failure in the vehicles. The failure probability information is used so that the controller 13 can preferentially select a vehicle with a lower probability of failure as the vehicle that is to be dispatched to the facility 41 located in the disaster area. The failure probability information may include information on a failure history, a repair history, and a total travel distance of each relief vehicle 20.

In normal times when no disaster has occurred, the controller 13 can accept registration of driver information from the drivers 30. The drivers 30 can register various types of information on the information processing apparatus 10, by operating the second information terminals 31. The controller 13 acquires the driver information via the communication interface 11 and stores it in the memory 12 (Step S102). The driver information can also be inputted by the operator of the information processing apparatus 10 through the input interface 14, based on information that has been received from the drivers 30.

The driver information stored in the memory 12 includes information identifying the drivers 30 (e.g., the names of the drivers 30), information on how to contact the drivers 30 (e.g., their email addresses), and information on positions at which the drivers 30 are normally located. The information on the positions at which the drivers 30 are normally located is secondary positional information. The information on the positions at which the drivers 30 are normally located may be, for example, information indicating the positions of homes of the drivers 30. The positions at which the drivers 30 are normally located may be specified, for example, by latitudes and longitudes.

The driver information stored in the memory 12 may include secondary vehicle attribute information indicating the attributes of vehicles normally driven by the drivers 30. As is the case with the primary vehicle attribute information, the secondary vehicle attribute information may include information on the type, size, and maneuverability of each vehicle.

The primary vehicle attribute information and the secondary vehicle attribute information can be used for determination of a combination of a relief vehicle 20 and a driver 30 in case of a disaster.

The driver information stored in the memory 12 may include history information indicating whether the drivers have driven any of the relief vehicles 20 in the past as a volunteer in case of a disaster. The history information may be information that the drivers 30 have registered by themselves. The history information may be automatically updated in the information processing apparatus 10 each time a driver 30 is dispatched to a disaster area 40.

The order of the process in Step S101 and the process in Step S102 may be changed. That is, Step S101 may be performed after Step S102. Steps S101 and Step S102 may be performed a plurality of times in succession. Step S101 and Step S102 may be performed in parallel. In normal times when no disaster has occurred and when there is no facility 41 in need of relief (Step S103: No), the controller 13 continuously accepts registration of relief vehicle information and driver information, and updates the relief vehicle information and the driver information stored in the memory 12 as appropriate.

Next, a case will be described in which a disaster has occurred and a facility 41 located in a disaster area 40 is in need of relief (Step S103: Yes). The controller 13 can determine that there is a facility 41 in need of relief, in response to an input made through the communication interface 11 or the input interface 14.

The controller 13 acquires information on the needs of a facility 41 located in the disaster area 40 in need of relief, through the communication interface 11 or the input interface 14 (Step S104). The information on the needs may be transmitted from the facility 41 or from a municipality in the disaster area 40. The information on the needs includes positional information for the facility 41, contact information, and information on the relief needed. The relief needed by the facility 41 may include supply of electric power, provision of products and persons as relief supplies and volunteers, provision of vehicles as places to sleep overnight, or the like. In a case in which the relief needed is supply of electric power, the information on the needs may include information on the electrical energy needed by the facility 41. In a case in which the relief needed is provision of products, the information on the needs may include information on the types and quantity of products needed by the facility 41. In a case in which the relief needed is provision of persons, the information on the needs may include information on the count of volunteers needed by the facility 41.

Upon acquiring the information on the needs of the facility 41 in the disaster area 40, the controller 13 determines a combination of a relief vehicle 20 and a driver 30 based on the relief vehicle information, the driver information, and the information on the needs (Step S105). An example of a method for determining the combination of the relief vehicle 20 and the driver 30 will be described with reference to FIG. 5.

The controller 13 searches the relief vehicle information stored in the memory 12 and extracts one or more relief vehicles 20 that match the information on the needs (Step S201). The count of relief vehicles 20 to be extracted may be greater than the count of relief vehicles 20 determined to be needed based on the information on the needs.

For example, in a case in which the information on the needs includes information on the electrical energy needed by the facility 41, the controller 13 searches the relief vehicle information and extract a plurality of candidates for the relief vehicles 20 that includes information on electric power that can be supplied. In this case, the extracted relief vehicles 20 are power supply vehicles. The controller 13 may calculate the count of relief vehicles 20 required to supply the electrical energy needed by the facility 41 and the timing of provision to the facility 41, based on the information on the electric power that can be supplied by the relief vehicles 20.

For example, in a case in which the information on the needs includes information on products needed by the facility 41, the controller 13 searches the relief vehicle information and extracts a plurality of relief vehicles 20 that can transport the products needed. The controller 13 may refer to information on loadable volume that is included in the relief vehicle information and preferentially extract vehicles into which a large volume can be loaded. Based on the information on loadable volume that is included in the relief vehicle information, the controller 13 can calculate the count of vehicles required to transport the quantity of products needed.

For example, in a case in which the information on the needs includes information on the count of volunteers needed by the facility 41, the controller 13 searches the relief vehicle information and extracts relief vehicles 20 that are suitable for transporting persons. The controller 13 may refer to information on the count of persons who can board that is included in the relief vehicle information, and preferentially extract vehicles that can be boarded by a large count of persons. Based on the information on the count of persons that is included in the relief vehicle information, the controller 13 can calculate the count of relief vehicles 20 required to transport the count of persons needed.

For example, in a case in which the information on the needs includes information on equipment needed by the facility 41, the controller 13 searches the relief vehicle information and extracts relief vehicles 20 with the equipment. For example, in a case in which the information on the needs includes vehicles in which one can sleep overnight, vehicles provided with equipment that allows one to sleep overnight in there are extracted from the relief vehicle information.

Subsequent to Step S201, the controller 13 selects a relief vehicle 20 to be dispatched to the facility 41 located in the disaster area 40 from among the plurality of extracted relief vehicles 20, by considering information on their normally located positions and failure probability information that are included in the relief vehicle information (Step S202). The controller 13 can preferentially select a relief vehicle 20 that is located at a position closer to the facility 41 in the disaster area 40. Consequently, relief can be more quickly provided to the facility 41. The controller 13 can preferentially select a relief vehicle 20 that is determined to have a lower probability of failure. Consequently, relief can be more reliably provided to the facility 41. In a case in which the failure probability information includes information on a failure history, the controller 13 may determine that a vehicle with no or a limited history of failure has a lower probability of failure. In a case in which the failure probability information includes information on a repair history, the controller 13 may determine that a vehicle with no or a limited history of repair has a lower probability of failure. In a case in which the failure probability information includes information on a total travel distance, the controller 13 may determine that a vehicle with a shorter total travel distance has a lower probability of failure.

Subsequent to Step S202, the controller 13 selects a driver 30 to be combined with the selected relief vehicle 20, based on the relief vehicle information and the driver information (Step S203).

In selecting a combination of the relief vehicle 20 and a driver 30, information on the positions at which the relief vehicles 20 are normally located that is included in the relief vehicle information, and information on the positions at which the drivers 30 are normally located that is included in the driver information are considered. The controller 13 preferentially selects a driver 30 who is normally located at a position closer to the position at which the relief vehicle 20 is normally located.

In selecting a combination of the relief vehicle 20 and a driver 30, the primary vehicle attribute information included in the relief vehicle information and the secondary vehicle attribute information included in the driver information are considered. When a driver 30 is combined with a relief vehicle 20 whose attribute is significantly different from that of a vehicle normally driven by the driver 30, the driver 30 may find it difficult to drive the relief vehicle 20. In an embodiment, therefore, the combination of the relief vehicle 20 and a driver 30 is determined so that the attribute of the relief vehicle 20 and the attribute of the vehicle normally driven by the driver 30 are identical or similar.

For example, the controller 13 determines the combination, by prioritizing a combination of the relief vehicle 20 and a driver 30 in which vehicle type information included in the primary vehicle attribute information and vehicle type information included in the secondary vehicle attribute information are more similar. The controller 13 determines the combination, by prioritizing a combination of the relief vehicle 20 and a driver 30 in which vehicle size information included in the primary vehicle attribute information and vehicle size information included in the secondary vehicle attribute information are closer. This allows the driver 30 to drive the relief vehicle 20 with a feel for the width and height similar to that of the vehicle normally driven by the driver 30.

Similarly, for example, the controller 13 may determine the combination of the relief vehicle 20 and a driver 30, by prioritizing a combination of the relief vehicle 20 and a driver 30 in which vehicle maneuverability information included in the primary vehicle attribute information and vehicle maneuverability information included in the secondary vehicle attribute information are more similar. This allows the driver 30 to drive the relief vehicle 20 with less stress, without being perplexed by the difference in maneuverability between the relief vehicle 20 and the vehicle normally driven by the driver 30.

In selecting the combination of the relief vehicle 20 and a driver 30, history information included in the relief vehicle information may be considered. The controller 13 can preferentially select a driver who has driven any of the plurality of relief vehicles 20 a greater number of times in the past, based on the history information. By doing so, a driver 30 who has the experience of driving a relief vehicle 20 a greater number of times in the past can be combined with the relief vehicle 20, so that the disaster area relief system 1 can provide more reliable relief.

In Step S203, it is sometimes impossible to determine an appropriate driver 30 to be combined with the relief vehicle 20 that has been selected in Step S202. For example, in a case in which all the positions at which the drivers 30 are located are more than a predetermined distance away from the position at which the selected relief vehicle 20 is located, the controller 13 may determine that it is impossible to select an appropriate driver 30 for the relief vehicle 20. Alternatively, the controller 13 can inquire the manager of the relief vehicle 20 and the driver 30 who have been selected in Step S203 about whether dispatch can be made to the facility 41, from the information processing apparatus 10 in Step S204. If the manager of the relief vehicle 20 and/or the driver 30 do/does not accept the dispatch, the combination of the relief vehicle 20 and the driver 30 is not established. In a case in which an appropriate combination of the relief vehicle 20 and a driver 30 has not been established (Step S204: No), the controller 13 may return to Step S202 and reselect another relief vehicle 20 that matches the information on the needs, in place of the relief vehicle 20 for which a combination has not been established. In this case, the controller 13 repeats the process from Step S202 onward.

In a case in which the combination of the relief vehicle 20 and the driver 30 has been established (Step S204: Yes), the controller 13 determines the combination of the relief vehicle 20 and the driver 30 (Step S205).

The method for determining a combination of a relief vehicle 20 and a driver 30 is not limited to the method illustrated in Step S201 through Step S205 above. The method illustrated in Step S201 through Step S205 is merely an example. For example, instead of selecting a relief vehicle 20 and then a driver 30, the controller 13 may first determine a plurality of combinations of relief vehicles 20 and drivers 30, and then select a combination of a relief vehicle 20 and a driver 30 that matches the information on the needs.

Subsequent to Step S205, the controller 13 determines a schedule according to which the relief vehicle 20 and the driver 30 are to travel to the facility 41. The schedule includes a schedule for the driver 30 to travel to a position at which the relief vehicle 20 is located and board the relief vehicle 20. The schedule may include a schedule for the relief vehicle 20 and the driver 30 to travel to the base 50 and load products or persons. The schedule may include a return schedule for the driver 30 who has arrived at the facility 41.

The schedule may consider the timing of arrival of the relief vehicle 20 at the facility 41. For example, in a case in which the information on the needs includes supply of electric power, the controller 13 dispatches the relief vehicle 20, which is a power supply vehicle, at an appropriate timing so that the electric power of a required capacity can be continuously supplied to the facility 41. For example, in a case in which there are a plurality of relief vehicles 20 that can supply five hours of electric power to the facility 41, the controller 13 may determine a schedule so that a relief vehicle 20, which is a power supply vehicle, will arrive at the facility 41 every five hours. The controller 13 may determine the schedule so that after driving the relief vehicle 20, which is a power supply vehicle, and arriving at the facility 41, the driver 30 can board another relief vehicle 20A that has already performed power supply and return toward their normally located position.

Upon determining the schedule, the controller 13 can transmit information on the schedule to the first information terminal 21 in the possession of the manager of the relief vehicle 20 and to the second information terminal 31 in the possession of the driver 30, via the communication interface 11 (Step S107). The schedule transmitted by the controller 13 may be not the entire but only part of the schedule. For example, the controller 13 may notify the manager of the relief vehicle 20 only of a departure time and a return time for the relief vehicle 20. For example, the controller 13 may notify the driver 30 of the next destination and target arrival time in a sequential order. By the driver 30 driving the relief vehicle 20 according to the schedule, electric power, products, persons, and equipment needed can be delivered at an appropriate timing to the facility 41.

As described above, by using the information processing apparatus 10 according to the present embodiment, in case of a disaster, an appropriate combination of a relief vehicle 20 and a driver 30 can be selected in accordance with information on needs, so that relief can be efficiently provided to a facility 41 in a disaster area 40.

Additionally, the present disclosure is not limited to the above embodiment, and various modifications and revisions may be implemented. For example, functions or the like included in each means, each step, or the like can be rearranged without logical inconsistency, and a plurality of means, steps, or the like can be combined into one or divided.

In the above embodiment, it is assumed that the information processing apparatus 10 accepts registration of relief vehicle information and driver information in normal times, and these types of information are stored in the memory. The relief vehicle information and the driver information may be, however, registered on another computer, and in case of a disaster, the controller 13 may acquire these types of information from the other computer and store them in the memory 12 as required.

The processes disclosed herein can also be provided as a program executed by a general purpose computer. Specifically, a program in which processes for realizing the functions of the information processing apparatus 10 according to the above embodiment are written may be stored in a memory of a general purpose computer, and the program may be read and executed by a processor. Accordingly, the present disclosure according to the present embodiment can also be implemented as a program executable by a processor, or a non-transitory computer readable medium storing the program.

1. An information processing apparatus, comprising: a memory configured to store primary information regarding a plurality of relief vehicles that can be dispatched to a facility located in a disaster area in case of a disaster and secondary information regarding a plurality of drivers who can drive relief vehicles in case of a disaster; and a controller configured to acquire tertiary information regarding a facility located in a disaster area in need of relief and perform processing for determining a combination of a relief vehicle included in the plurality of relief vehicles and a driver included in the plurality of drivers that is to be dispatched to the facility located in the disaster area, based on the primary information, the secondary information, and the tertiary information.

2. The information processing apparatus according to claim 1, further comprising a communication interface configured to transmit and receive information to and from the outside, wherein the controller is configured to determine a schedule according to which the driver is to board the relief vehicle and the relief vehicle is to travel to the facility and transmit the schedule to a first information terminal in possession of a manager of the relief vehicle and to a second information terminal in possession of the driver, via the communication interface.

3. The information processing apparatus according to claim 1, wherein the primary information includes primary vehicle attribute information indicating respective attributes of the plurality of relief vehicles, and the secondary information includes secondary vehicle attribute information indicating attributes of respective vehicles normally driven by the plurality of drivers, and the controller is configured to determine the combination of the relief vehicle and the driver, based on the primary vehicle attribute information and the secondary vehicle attribute information.

4. The information processing apparatus according to claim 3, wherein the primary vehicle attribute information and the secondary vehicle attribute information each include vehicle type information, and the controller is configured to determine the combination, by prioritizing a combination of a relief vehicle and a driver in which the vehicle type information included in the primary vehicle attribute information and the vehicle type information included in the secondary vehicle attribute information are identical or more similar to each other.

5. The information processing apparatus according to claim 3, wherein the primary vehicle attribute information and the secondary vehicle attribute information each include vehicle size information, and the controller is configured to determine the combination, by prioritizing a combination of a relief vehicle and a driver in which the vehicle size information included in the primary vehicle attribute information and the vehicle size information included in the secondary vehicle attribute information are closer to each other.

6. The information processing apparatus according to claim 3, wherein the primary vehicle attribute information and the secondary vehicle attribute information each include maneuverability information, and the controller is configured to determine the combination, by prioritizing a combination of a relief vehicle and a driver in which the maneuverability information included in the primary vehicle attribute information and the maneuverability information included in the secondary vehicle attribute information are identical more similar to each other.

7. The information processing apparatus according to claim 1, wherein the primary information includes primary positional information indicating respective positions of the plurality of relief vehicles, and the secondary information includes secondary positional information indicating positions of the plurality of drivers, and the controller is configured to determine the combination, by prioritizing a combination of a relief vehicle and a driver in which the primary positional information and the secondary positional information are closer to each other.

8. The information processing apparatus according to claim 1, wherein the primary information includes failure probability information indicating probabilities of occurrence of failure, and the controller is configured to preferentially select a vehicle with a lower probability of failure as the vehicle that is to be dispatched to the facility located in the disaster area in case of the disaster, based on the failure probability information.

9. The information processing apparatus according to claim 8, wherein the failure probability information includes a failure history, a repair history, and/or a total travel distance of each of the plurality of relief vehicles.

10. The information processing apparatus according to claim 1, wherein the secondary information includes history information indicating whether the drivers have driven any of the plurality of relief vehicles in the past in case of a disaster, and the controller is configured to preferentially select a driver who has driven any of the plurality of relief vehicles a greater number times in the past, based on the history information.

11. The information processing apparatus according to claim 1, wherein the tertiary information is configured to include information on electrical energy needed by the facility, and the primary information includes information on capacity of electric power that can be supplied by each of the plurality of relief vehicles.

12. The information processing apparatus according to claim 1, wherein the tertiary information is configured to include information on products needed by the facility, and the primary information includes information on volume loadable into each of the plurality of relief vehicles.

13. The information processing apparatus according to claim 1, wherein the tertiary information is configured to include information on a count of persons needed by the facility, and the primary information includes information on a count of persons who can board each of the plurality of relief vehicles.

14. A method, executed by a controller of an information processing apparatus, for determining a combination of a relief vehicle and a driver, the method comprising: acquiring primary information regarding a plurality of relief vehicles that can be dispatched to a facility located in a disaster area in case of a disaster; acquiring secondary information regarding a plurality of drivers who can drive relief vehicles in case of a disaster; acquiring tertiary information regarding a facility located in a disaster area in need of relief; and determining a combination of a relief vehicle included in the plurality of relief vehicles and a driver included in the plurality of drivers that is to be dispatched to the facility located in the disaster area, based on the primary information, the secondary information, and the tertiary information.

15. The method according to claim 14, comprising determining a schedule according to which the driver is to board the relief vehicle and the relief vehicle is to travel to the facility and transmitting the schedule to a first information terminal in possession of a manager of the relief vehicle and to a second information terminal in possession of the driver.

16. The method according to claim 14, wherein the primary information includes primary vehicle attribute information indicating respective attributes of the plurality of relief vehicles, and the secondary information includes secondary vehicle attribute information indicating attributes of respective vehicles normally driven by the plurality of drivers, and the determining comprises determining the combination of the relief vehicle and the driver, based on the primary vehicle attribute information and the secondary vehicle attribute information.

17. The method according to claim 14, wherein the primary information includes primary positional information indicating respective positions of the plurality of relief vehicles, and the secondary information includes secondary positional information indicating positions of the plurality of drivers, and the determining comprises determining the combination, by prioritizing a combination of a relief vehicle and a driver in which the primary positional information and the secondary positional information are closer to each other.

18. The method according to claim 14, wherein the primary information includes failure probability information indicating probabilities of occurrence of failure, and the determining comprises preferentially selecting a vehicle with a lower probability of failure as the vehicle that is to be dispatched to the facility located in the disaster area in case of the disaster, based on the failure probability information.

19. The method according to claim 14, wherein the secondary information includes history information indicating whether the drivers have driven any of the plurality of relief vehicles in the past in case of a disaster, and the determining comprises preferentially selecting a driver who has driven any of the plurality of relief vehicles a greater number times in the past, based on the history information.

20. A non-transitory computer readable medium storing a program configured to cause a computer to execute operations comprising: acquiring primary information regarding a plurality of relief vehicles that can be dispatched to a facility located in a disaster area in case of a disaster; acquiring secondary information regarding a plurality of drivers who can drive relief vehicles in case of a disaster; acquiring tertiary information regarding a facility located in a disaster area in need of relief; and determining a combination of a relief vehicle included in the plurality of relief vehicles and a driver included in the plurality of drivers that is to be dispatched to the facility located in the disaster area, based on the primary information, the secondary information, and the tertiary information.
